(19) United States
(12) Patent Application Publication
(10) Pub. No.: US 2010/0133986 A1
(43) Pub. Date: Jun. 3, 2010

(54) LIGHT EMISSION DEVICE AND DISPLAY DEVICE USING SAME AS LIGHT SOURCE

(76) Inventors: Yoon-Jin Kim, Anyang-si (KR); Jae-Myung Kim, Suwon-si (KR); Kyu-Nam Joo, Suwon-si (KR); Jong-Hee Lee, Suwon-si (KR); So-Ra Lee, Suwon-si (KR); Jae-Sun Jeong, Lausanne (CH)

Correspondence Address: CHRISTIE, PARKER & HALE, LLP, PO BOX 7068, PASADENA, CA, 91109-7068, US

(21) Appl. No.: 12/630,706

(22) Filed: Dec. 3, 2009

(30) Foreign Application Priority Data
Dec. 3, 2008 (KR) 10-2008-0122096

(51) Int. Cl. H01J 1/62

(52) U.S. Cl. 313/497

(57) ABSTRACT

A light emission device includes: a first substrate and a second substrate arranged opposite each other with a vacuum region therebetween; an electron emission region located at a side of the first substrate facing the second substrate; a driving electrode located on the first substrate and for controlling an emitting current amount (e.g., magnitude) of the electron emission region; an anode located at a side of the second substrate facing the first substrate; a phosphor layer on one surface of the anode and corresponding to pixel areas; and a spray coated Ag reflective layer covering the phosphor layer and having reflectivity between about 90% and about 99.9%.

### CROSS-REFERENCE TO RELATED APPLICATIONS

This application claims priority to and the benefit of Korean Patent Application No. 10-2008-0122096 filed in the Korean Intellectual Property Office on Dec. 3, 2008, the entire disclosure of which is incorporated herein by reference.

### BACKGROUND

1. Field

This disclosure relates to a light emission device and a display device using the same as a light source.

2. Description of the Related Art

All devices that emit light when seen from the outside are defined as light emission devices. A light emission device including a front substrate having an anode and a phosphor layer and a rear substrate having an electron emission region and a driving electrode is commonly known. The front substrate and the rear substrate are joined at the edges thereof by a sealing member, and the inside space is evacuated to provide a vacuum container together with the sealing member.

The driving electrode may include cathode electrodes and gate electrodes arranged to perpendicularly cross each other. In this case, the electron emission region is formed on the cathode of every crossing area of the cathode electrodes and the gate electrodes. Alternatively, the driving electrode may have a comb pattern and that includes alternately arranged cathode electrodes and gate electrodes. The electron emission region is located on the side of the cathode facing the gate electrode.

The light emission device has a plurality of pixels associated with the cathode electrodes and the gate electrodes. A driving voltage is applied to the cathode electrodes and the gate electrodes to control the output current (e.g., magnitude) of the electron emission region, thereby controlling the luminance of a phosphor layer on a per pixel basis. The light emission device may be used as a light source in a display device having a non-self-emission display panel such as a liquid crystal display panel.

### SUMMARY

One aspect of an embodiment according to the present invention provides a light emission device that is capable of improving the cathode luminescence efficiency of the phosphor layer by improving a reflective efficiency of a reflective layer.

Another aspect of an embodiment according to the present invention provides a display device using the light emission device as a light source.

According to one embodiment of the present invention, a light emission device is provided that includes: a first substrate and a second substrate arranged opposite each other with a vacuum region therebetween; an electron emission region located at a side of the first substrate facing the second substrate; a driving electrode located on the first substrate and for controlling an emitting current (e.g., magnitude) of the electron emission region; an anode located at a side of the second substrate facing the first substrate; a phosphor layer on one surface of the anode and corresponding to pixel areas; and a spray coated Ag reflective layer covering the phosphor layer and having reflectivity between about 90% and about 99.9%.

According to another aspect of an embodiment according to the present invention, the reflective layer may have a thickness between about 50 nm and about 300 nm.

The reflective layer may be formed by applying a Ag composition including a Ag salt or Ag nanoparticles, a dispersing agent, an antifoaming agent, and a solvent on one surface of the phosphor layer using a spraying method, and drying it. The Ag salt may include one selected from the group including Ag acetate, Ag nitrate, Ag chloride, and combinations thereof. The Ag nanoparticles may have an average particle size between about 1 nm and about 100 nm.

According to another aspect of an embodiment according to the present invention, the phosphor layer may include a white phosphor, which is a mixture of a red phosphor, a green phosphor, and a blue phosphor. The red phosphor may be selected from the group including Y₂O₃:Eu, Y₂O₂S:Eu, SrTiO₃:Pr, and combinations thereof, the green phosphor may be selected from the group including Y₂SiO₅:Tb, Gd₂O₂S:Tb, ZnS:(Cu,Al), ZnSiO₄:Mn, Zn (Ga,Al)₂O₄:Mn, SrGa₂S₄:Eu, and combinations thereof, and the blue phosphor may be selected from the group consisting of ZnS:(Ag,Al), Y₂SiO₅:Ce, BaMgAl₁₀O₁₇:Eu, and combinations thereof. The weight ratio of the red phosphor, the green phosphor, and the blue phosphor in the mixture may be between about 15:30:24 and about 30:60:45.

According to another aspect of an embodiment according to the present invention, the driving electrode may comprise a cathode electrode and a gate electrode crossing each other and having an insulation layer therebetween, and one or more crossing regions overlapped by the cathode and gate electrodes correspond to the pixel areas.

According to another aspect of an embodiment according to the present invention, the Ag reflective layer may be spaced from the phosphor layer.

According to another aspect of an embodiment according to the present invention, a display device including the light emission device and a display panel located in front of the light emission device is provided.

The display panel may include a plurality of first pixels, wherein the light emission device includes a plurality of second pixels of a lesser number than that of the first pixels of the display panel, and wherein each of the second pixels is configured to independently emit light corresponding to gray levels of corresponding ones of the first pixels. The display panel may be a liquid crystal panel.

Other aspects of embodiments according to the present invention are described in the following detailed description.

### BRIEF DESCRIPTION OF THE DRAWINGS

FIG. 1 is a partial cross-sectional view showing a light emission device according to a first embodiment of the present invention.

FIG. 2 is an exploded perspective view showing the inside of an effective region of the light emission device shown in FIG. 1.

FIG. 3 is a partial cross-sectional view showing the light emission device according to a second embodiment of the present invention.

FIG. 4 is an exploded perspective view showing the display device according to a third embodiment of the present invention.

FIG. 5 is a partial cross-sectional view showing the display device shown in FIG. 4.

FIG. 6 is a graph showing reflectivity of reflective layers obtained from Example 1 and Comparative Examples 1 to 3.

FIG. 7 is a graph showing reflectivity of reflective layers obtained from Examples 1 to 3 and Comparative Example 1.

### DETAILED DESCRIPTION

Exemplary embodiments of this disclosure will hereinafter be described in detail. However, these embodiments are only exemplary, and this disclosure is not limited thereto.

The light emission device according to one aspect of an embodiment according to the present invention includes a first substrate and a second substrate arranged opposite each other with a vacuum region therebetween; an electron emission region located at a side of the first substrate facing the second substrate; a driving electrode located on the first substrate and for controlling an emitting current (e.g., magnitude) of the electron emission region; an anode located at a side of the second substrate facing the first substrate; a phosphor layer formed on one surface of the anode and corresponding to the pixel areas; and a spray coated silver (Ag) reflective layer covering the phosphor layer and having reflectivity between about 90% and about 99.9%.

A silver (Ag) reflective layer may be located on one surface of the phosphor layer formed on the front substrate. The Ag reflective layer reflects the visible light emitted toward the rear substrate among the visible light emitted from the phosphor layer toward the front substrate to increase the luminance of the light emitting surface. Such a Ag reflective layer is also known as a metal back layer. In order to improve the cathode luminescence (CL) efficiency of the phosphor layer, research for improving reflective efficiency of Ag reflective layer is in progress.

According to embodiments of the present invention, the reflective layer may be provided by applying a silver (Ag) composition including but not limited to, a Ag salt or Ag nanoparticles, a dispersing agent, an antifoaming agent, and a solvent onto the phosphor layer using a spraying method, and drying it.

The Ag salt includes one or more of, but not limited to, Ag acetate, Ag nitrate, Ag chloride, or a combination thereof. The Ag nanoparticles may be nano-sized Ag particles, for example having an average particle size between about 1 nm and about 100 nm.

The dispersing agent includes a quadribasic acid such as ethylenediamine tetraacetic acid, and the antifoaming agent may include a generally-used antifoaming agent such as silicon or silica.

The solvent includes one or more of, but not limited to, methanol, ethanol, tetradecane, or a combination thereof.

In the composition, the Ag salt or Ag nanoparticles may be used in an amount between about 1 wt % and about 60 wt %, the dispersing agent and antifoaming agent may be used in an amount of 5 wt % or less, and the solvent may be used at a balance amount. The amounts of the dispersing agent, antifoaming agent, and solvent are not necessarily limited.

The drying process is performed at a temperature range between about 60° C. and about 120° C.

Ag ions of the Ag salt are reduced to Ag to form a reflective layer through the drying process, and the reflective layer may be very dense and has substantially uniform thickness. In one embodiment of the present invention, Ag is used after forming an interlayer or lacquer layer, and a Ag spraying method under an air atmosphere is used instead of vacuum thermal evaporation. A reflective layer formed by the Ag spraying method according to one embodiment is very dense and smooth.

Such a smooth reflective layer has excellent reflectivity between about 90% and about 99.9%. This high reflectivity may improve cathode luminescence efficiency of a phosphor.

The reflective layer may have a thickness between about 50 nm and about 300 nm.

The reflective layer of the light emission device includes fine holes for transmitting an electron beam and reflects the visible light emitted toward the first substrate among the visible light emitted from the phosphor layer to the second substrate, so as to improve the luminance of the light emitting surface. The fine holes may be formed through laser processing.

The phosphor layer may be formed with a white phosphor, which is a mixture of a red phosphor, a green phosphor, and a blue phosphor. The red phosphor includes one or more of, but not limited to, Y₂O₃:Eu, Y₂O₂S:Eu, SrTiO₃:Pr, and combinations thereof, and the green phosphor includes one or more of, but not limited to, Y₂SiO₅:Tb, Gd₂O₂S:Tb, ZnS:(Cu,AI), ZnSiO₄:Mn, Zn(Ga,Al)₂O₄:Mn, SrGa₂S₄:Eu, and combinations thereof. In addition, the blue phosphor includes one or more of, but not limited to, ZnS:(Ag,Al), Y₂SiO₅:Ce, BaMgAl₁₀O₁₇:Eu, and combinations thereof. According to one embodiment, in the phosphor layer, the red phosphor, the green phosphor, and the blue phosphor are mixed in a weight ratio between about 15:30:24 and about 30:60:45. When the mixing ratio of the red phosphor, the green phosphor, and the blue phosphor is within the range, and it is applied to the light emission device and the light emission device is used for a light source of a display device to provide white light, the light generated from the light-emission device has excellent luminance and suitable color coordinates after transmitting from the display panel.

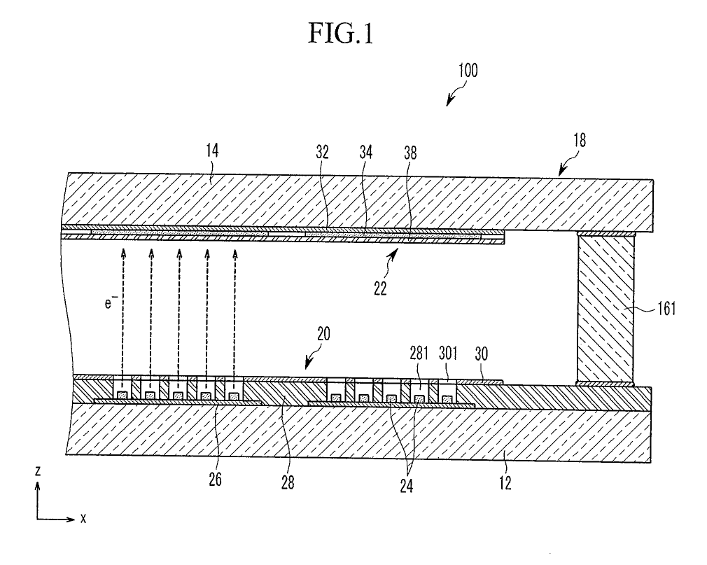

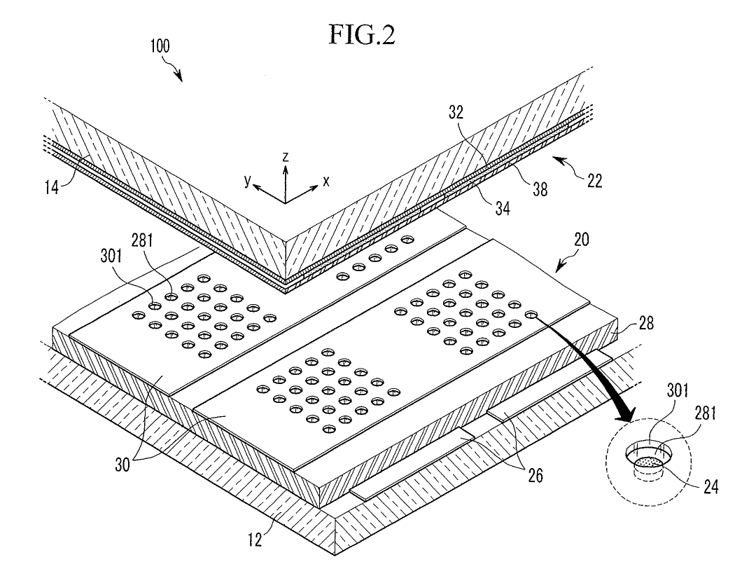

Hereinafter, an exemplary embodiment of the light emission display having the reflective layer is illustrated with reference to FIGS. 1 and 2. However, FIG. 1 and FIG. 2 illustrate only one embodiment of a light emission device having the reflective layer according to the present invention, and it is not limited thereto. FIG. 1 is a partial cross-sectional view showing one embodiment of the present invention, and FIG. 2 is an exploded perspective view of the inside of an effective region of the light emission device shown in FIG. 1.

The light emission device 100 includes a first substrate 12 and a second substrate 14 arranged opposite to each other with a gap (e.g., a predetermined distance) therebetween. At the edge of the first substrate 12 and the second substrate 14, a sealing member 16 is located to join the substrates 12 and 14 together. The inside space is evacuated to a degree of vacuum of approximately 10⁻⁶ Torr, so a vacuum panel 18 is provided with the space enclosed by the first substrate 12, the second substrate 14, and the sealing member 16.

A region enclosed by the first substrate 12, the second substrate 14, and the sealing member 16 can be partitioned into an effective region that contributes to emission of visible light and a non-effective region surrounding the effective region. The effective region of the first substrate 12 includes an electron emitting unit 20 for emitting electrons, and the effective region of the second substrate 14 includes a light emitting unit 22 for emitting visible light.

The electron emission unit 20 includes an electron emission region 24 and driving electrodes for controlling emission current amount (e.g., magnitude) of the electron emission region 24. The driving electrodes include cathode electrodes 26 forming a stripe pattern along one direction (y axis direction in the drawing) of the first substrate 12 and gate electrodes 30 forming a stripe pattern along the direction (x axis direction in the drawing) crossing the cathode electrodes 26 with an insulation layer 28 therebetween.

The gate electrodes 30 and the insulation layer 28 respectively have openings 301 and 281 at crossing regions of cathode electrodes 26 and gate electrodes 30 to expose a part of the cathode electrode 26 surface, and an electron emission region 24 is formed on the cathode electrode 26 inside the opening 281 of the insulation layer. The electron emission region 24 may include any material selected from materials that emit electrons when an electric field is applied under vacuum, such as one or more of, but not limited to, carbon nanotubes, graphite, graphite nanofiber, diamond-like carbon, fullerene, silicon nano-wire, and combinations thereof.

One crossing region overlapping the cathode electrode 26 and the gate electrode 30 may correspond to one pixel area of the light emission device 100, or two or more crossing regions may correspond to one pixel area of the light emission device 100.

In one embodiment, the light emitting unit 22 includes an anode 32, a phosphor layer 34 located on one surface of the anode 32, and a reflective layer 38 covering the phosphor layer 34. The anode 32 is formed with a transparent conductive material such as indium tin oxide (ITO) to maintain the phosphor layer 34 in a high potential state when it is applied with a high voltage (anode voltage) of 5 kV or more to transmit the visible light emitted from the phosphor layer 34.

The reflective layer 38 reflects the visible light emitted toward the first substrate 12 among the visible light emitted from the phosphor layer, to the second substrate 14 side, so as to increase the luminance of the light emission surface. In another embodiment, the anode 32 may be omitted, and the reflective layer 38 may then be applied with the anode voltage to function as an anode.

The phosphor layer 34 may be composed of a white phosphor, which may be a mixture of a red phosphor, a green phosphor, and a blue phosphor.

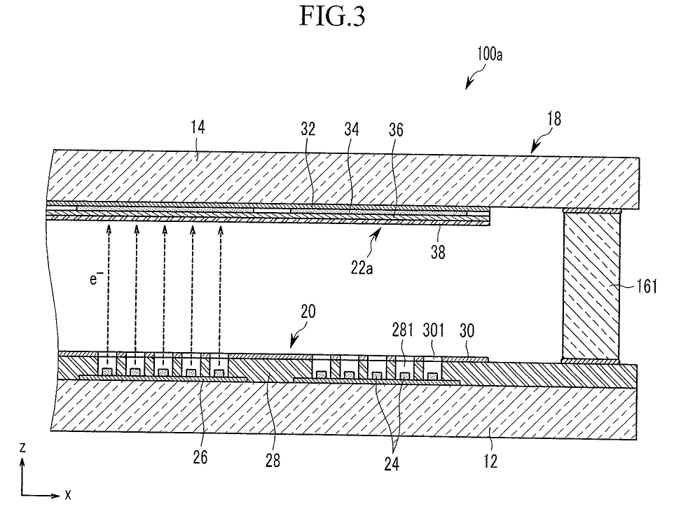

As shown in FIG. 3, in another embodiment, the light emitting unit 22a may further include an intermediate film 36 covering the phosphor layer 34 between the phosphor layer 34 and the reflective layer 38. The intermediate film secures a reflective space of visible light between the phosphor layer and the reflective layer, such that the phosphor layer is spaced from the reflective layer, to improve reflectivity. The intermediate film 36 is removed during a following baking process to provide the reflective space.

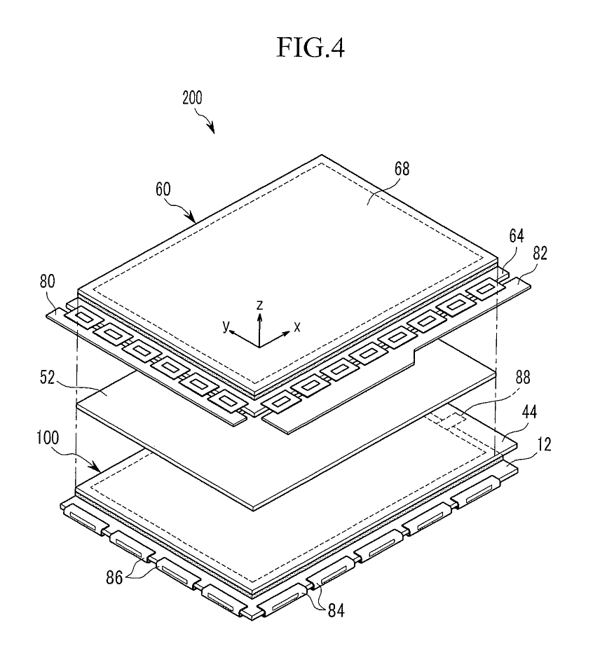

FIG. 4 shows a display device according to a third embodiment of the present invention using the light emission device as a light source.

As shown in FIG. 4, the display device 200 includes a light emission device 100 or 100a and a display panel 60 located in front of the light emission device 100 or 100a. A diffuser 52 is located between the light emission device 100 or 100a and the display panel 60 in the embodiment of FIG. 4. The display panel 60 includes a liquid crystal panel or another non-self-emissive display panel. Hereinafter, the display panel 60 will be described in reference to a liquid crystal display panel. In other embodiments, the diffuser 52 may not be used.

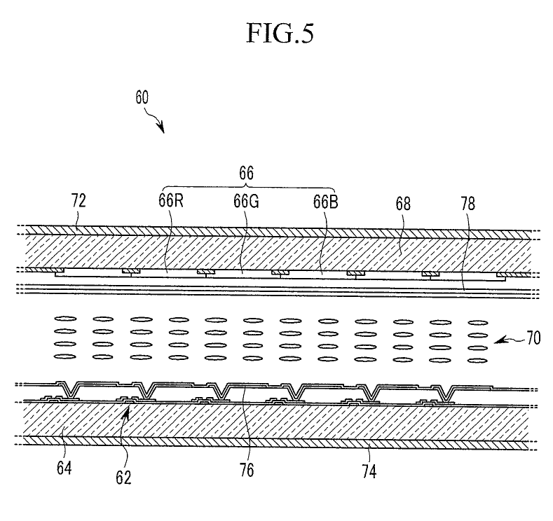

FIG. 5 is a partial cross-sectional view of the display panel shown in FIG. 4.

Referring to FIG. 5, the display panel 60 includes a lower substrate 64 formed with a plurality of thin film transistors (TFTs) 62, an upper substrate 68 formed with a color filter layer 66, and a liquid crystal layer 70 located between the substrates 64 and 68. Polarizers 72 and 74 are respectively attached on the upper surface of the upper substrate 68 and the lower surface of the lower substrate 64, to polarize light transmitted through the display panel 60.

Transparent pixel electrodes 76 of which the driving is controlled by a TFT 62 per subpixel are located on the inside surface of the lower substrate 64, and a transparent common electrode 78 is located on the inside surface of the upper substrate 68. The color filter layer 66 includes for each pixel a red filter layer 66R, a green filter layer 66G, and a blue filter layer 66B, of which a respective one is located per subpixel.

When a TFT 62 of a certain subpixel turns on, an electric field is formed between the pixel electrode 76 and the common electrode 78. The electric field changes the alignment angle of liquid crystal molecules, thereby changing the light transmission. The display panel 60 controls the luminance and the light emitting color per pixel through this process.

Referring back to FIG. 4, a gate printed circuit board assembly (PBA) 80 transmits the gate driving signal to each TFT gate electrode, and a data printed circuit board assembly (PBA) 82 transmits the data driving signal to each TFT source electrode.

The light emission device 100 or 100a may have fewer pixels than the display panel 60 to allow one pixel of the light emission device 100 or 100a to correspond to two or more pixels of the display panel 60. Each pixel of the light emission device 100 or 100a emits light in accordance with the highest gray level among gray levels of a plurality of corresponding display panel 60 pixels, and expresses gray levels corresponding to 2 to 8 bits.

For convenience of description, pixels of the display panel 60 may be referred to as first pixels and pixels of the light emission device 100 or 100a may be referred to as second pixels. The first pixels corresponding to one second pixel may be referred to as a first pixel group.

The light emission device 100 or 100a may be driven by a process including: detecting the highest gray level among gray levels of the first pixels in the first pixel group with a signal control part (not shown) controlling the display panel 60; calculating the gray level required to emit light in the second pixel depending upon the detected gray level to convert it to digital data; producing a driving signal of the light emission device 100 or 100a by using the digital data; and applying the produced driving signal to the driving electrode of the light emission device 100 or 100a.

The driving signal of the light emission device 100 or 100a includes a scan driving signal and a data driving signal. Any one electrode from the aforementioned cathode and gate electrode, for example the gate electrode, is applied with the scan driving signal, and the other electrode, for example the cathode, is applied with the data driving signal.

A scan printed circuit board assembly (PBA) and a data printed circuit board assembly (PBA) for driving the light emission device 100 or 100a may be located at the rear surface of the light emission device 100 or 100a. First connecting members 84 connect the cathode electrodes to the data printed circuit board assembly (PBA), and second connecting members 86 connect the gate electrodes to the scan printed circuit board assembly (PBA). A third connecting member 88 is for applying an anode voltage to the anode.

As mentioned above, when the image is expressed in the first pixel group corresponding to the second pixel of the light emission device 100 or 100a, the second pixel is synchronized with the first pixel group to emit light of a gray level in accordance with the gray levels of the first pixel group. In other words, the light emission device 100 or 100a provides high luminous light to a bright region in the image expressed by the display panel 60, but it provides low luminous light to a dark region. Accordingly, the display device 200 according to the exemplary embodiment increases the contrast ratio and accomplishes clearer image quality.

The following examples illustrate this disclosure in more detail. However, it is understood that this disclosure is not limited by these examples.

### Example 1

Ag acetate:ethylenediamine tetraacetic acid dispersing agent:silica antifoaming agent:solvent (tetradecane) were mixed at a ratio of 20:3:1:76 wt % to prepare a composition. The composition was spray-coated on one side of an interlayer on a phosphor layer of a first substrate shown in FIG. 3 and dried at 80° C. to form a reflective layer. The reflective layer had a thickness of 180 nm. A laser was radiated on the reflective layer to form holes of a 1 μm diameter at an interval of 10 μm in all directions, and the reflective layer was heat-treated at 490° C.

### Comparative Example 1

A Ag reflective layer was formed using vacuum thermal deposition on one side of an interlayer on a phosphor layer of a first substrate shown in FIG. 3.

### Comparative Example 2

An Al reflective layer was sputtered on one side of an interlayer on a phosphor layer of a first substrate shown in FIG. 3.

### Comparative Example 3

A Cr reflective layer was plated on one side of an interlayer on a phosphor layer of a first substrate shown in FIG. 3.

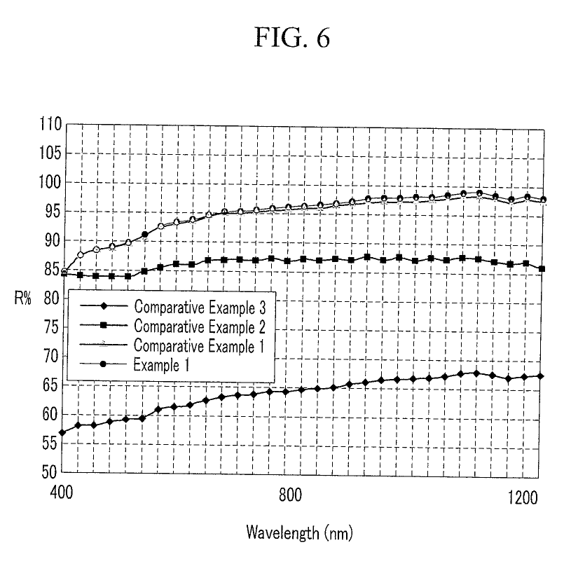

Reflectivities of the reflective layer of Example 1 and Comparative Examples 1 to 3 were measured, and the results are shown in the following Table 1 and FIG. 6.

TABLE 1

| Film | Comparative | Comparative | Comparative | Example 1 |
|---|---|---|---|---|
| forming | Example 1 | Example 2 | Example 3 | (Ag spray |
| method | (Ag deposit) | (Al sputtering) | (Cr plating) | coating) |
| Reflectivity | 98.35 | 85 | 65 | 98.52 |
| (%) | | | | |

As in Table 1 and FIG. 6, reflectivity of Example 1 using Ag spray coating is much higher than those of Comparative Examples 2 and 3. Reflectivity of Example 1 is slightly higher than that of Comparative Example 1 using vacuum thermal deposition. However, vacuum thermal deposition of Comparative Example 1 needs an additional apparatus and complicated processes. In particular, a thick film is difficult to form. Despite the additional complexity, its reflectivity is slightly less than that of Example 1.

### Example 2

A reflective layer was formed according to the same method as in Example 1, except that the thickness of the reflective layer was 210 nm.

### Example 3

A reflective layer was formed according to the same method as in Example 1, except that the thickness of the reflective layer was 320 nm.

### Example 4

A reflective layer was formed according to the same method as in Example 1, except that Ag nanoparticles having an average particle size of about 50 nm were used instead of Ag acetate.

Reflectivities (%) of the reflective layers according to Examples 1 to 3 and

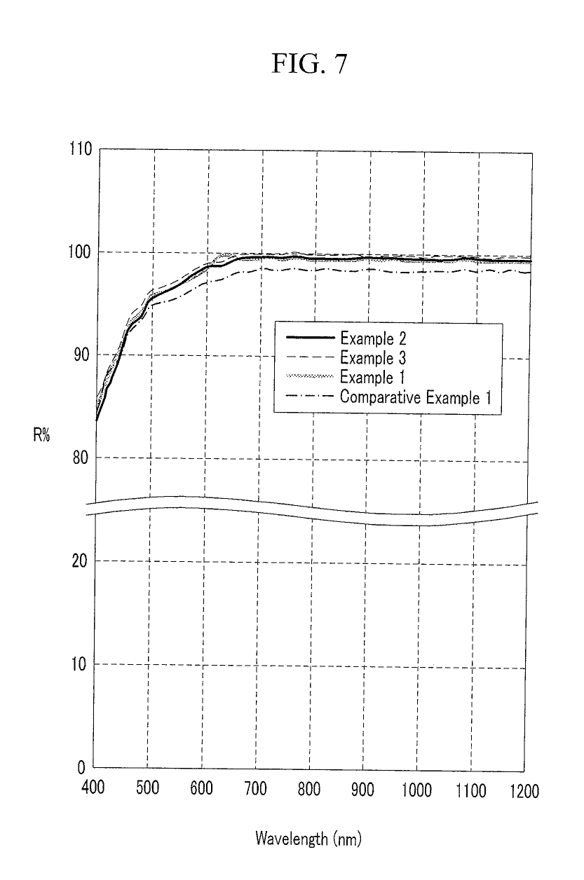

Comparative Example 1 were measured, and the results are shown in FIG. 7. As shown in FIG. 7, reflectivities of Examples 1 to 3 are much higher than that of Comparative Example 1. The reflectivity of the reflective layer according to of Example 4 is also much higher than that of Comparative Example 1.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and their equivalents. Therefore, the aforementioned embodiments should be understood to be exemplary but not limiting this disclosure in any way.

What is claimed is:

1. A light emission device comprising:
a first substrate and a second substrate arranged opposite each other with a vacuum region therebetween;
an electron emission region located at a side of the first substrate facing the second substrate;
a driving electrode located on the first substrate and for controlling an emitting current of the electron emission region;
an anode located at a side of the second substrate facing the first substrate;
a phosphor layer on one surface of the anode and corresponding to pixel areas; and
a spray coated Ag reflective layer covering the phosphor layer and having reflectivity between about 90% and about 99.9%.

2. The light emission device of claim 1, wherein the reflective layer has a thickness between about 50 nm and about 300 nm.

3. The light emission device of claim 1, wherein the reflective layer is formed by applying a Ag composition including a Ag salt or Ag nanoparticles, a dispersing agent, an antifoaming agent, and a solvent on one surface of the phosphor layer using a spraying method, and drying it.

4. The light emission device of claim 3, wherein the Ag salt comprises one selected from the group consisting of Ag acetate, Ag nitrate, Ag chloride, and combinations thereof.

5. The light emission device of claim 3, wherein the Ag nanoparticles have an average particle size between about 1 nm and about 100 nm.

6. The light emission device of claim 1, wherein the phosphor layer comprises a white phosphor, which is a mixture of a red phosphor, a green phosphor, and a blue phosphor.

7. The light emission device of claim 6, wherein the red phosphor is selected from the group consisting of Y₂O₃:Eu, Y₂O₂S:Eu, SrTiO₃:Pr, and combinations thereof, the green phosphor is selected from the group consisting of Y₂SiO₅:Tb, Gd₂O₂S:Tb, ZnS:(Cu,Al), ZnSiO₄:Mn, Zn(Ga,Al)₂O₄:Mn, SrGa₂S₄:Eu, and combinations thereof, and the blue phosphor is selected from the group consisting of ZnS:(Ag,Al), Y₂SiO₅:Ce, BaMgAl₁₀O₁₇:Eu, and combinations thereof.

8. The light emission device of claim 6, wherein a weight ratio of the red phosphor, the green phosphor, and the blue phosphor in the mixture is between about 15:30:24 and about 30:60:45.

9. The light emission device of claim 1, wherein the driving electrode comprises a cathode electrode and a gate electrode crossing each other and having an insulation layer therebetween, and one or more of crossing regions overlapped by the cathode and gate electrodes correspond to the pixel areas.

10. A display device comprising:
a light emission device comprising:
a first substrate and a second substrate arranged opposite each other with a vacuum region therebetween;
an electron emission region located at a side of the first substrate facing the second substrate;
a driving electrode located on the first substrate and for controlling an emitting current of the electron emission region;
an anode located at a side of the second substrate facing the first substrate;
a phosphor layer on one surface of the anode and corresponding to pixel areas; and
a spray coated Ag reflective layer covering the phosphor layer and having reflectivity between about 90% and about 99.9%; and
a display panel located in front of the light emission device.

11. The display device of claim 10, wherein the display panel comprises a plurality of first pixels, wherein the light emission device comprises a plurality of second pixels of a lesser number than that of the first pixels of the display panel, and wherein each of the second pixels is configured to independently emit light corresponding to gray levels of corresponding ones of the first pixels.

12. The display device of claim 10, wherein the display panel is a liquid crystal panel.

13. The display device of claim 10, wherein the reflective layer has a thickness between about 50 nm and about 300 nm.

14. The display device of claim 10, wherein the reflective layer is formed by applying a Ag composition including a Ag salt or Ag nanoparticles, a dispersing agent, an antifoaming agent, and a solvent on one surface of the phosphor layer using a spraying method, and drying it.

15. The display device of claim 14, wherein the Ag salt comprises one selected from the group consisting of Ag acetate, Ag nitrate, Ag chloride, and combinations thereof.

16. The display device of claim 14, wherein the Ag nanoparticles have an average particle size between about 1 nm and about 100 nm.

17. The display device of claim 10, wherein the phosphor layer comprises a white phosphor, which is a mixture of a red phosphor, a green phosphor, and a blue phosphor.

18. The display device of claim 17, wherein the red phosphor is selected from the group consisting of Y₂O₃:Eu, Y₂O₂S:Eu, SrTiO₃:Pr, and combinations thereof, the green phosphor is selected from the group consisting of Y₂SiO₅:Tb, Gd₂O₂S:Tb, ZnS:(Cu,Al), ZnSiO₄:Mn, Zn(Ga,Al)₂O₄:Mn, SrGa₂S₄:Eu, and combinations thereof, and the blue phosphor is selected from the group consisting of ZnS:(Ag,Al), Y₂SiO₅:Ce, BaMgAl₁₀O₁₇:Eu, and combinations thereof.

19. The display device of claim 17, wherein the weight ratio of the red phosphor, the green phosphor, and the blue phosphor is between about 15:30:24 and about 30:60:45

20. The display device of claim 10, wherein the driving electrode comprises a cathode electrode and a gate electrode crossing each other and having an insulation layer therebetween, and one or more of crossing regions overlapped by the cathode and the gate electrode correspond to the pixel areas.
